(19) United States
(12) Patent Application Publication
(10) Pub. No.: US 2019/0354335 A1
(43) Pub. Date: Nov. 21, 2019

(54) IMAGE DISPLAY SYSTEM, IMAGE DISPLAY DEVICE AND METHOD OF CONTROLLING IMAGE DISPLAY SYSTEM

(71) Applicant: SEIKO EPSON CORPORATION, Tokyo (JP)

(72) Inventor: Mitsuhiro YOSHIDA, Sapporo-shi (JP)

(73) Assignee: SEIKO EPSON CORPORATION, Tokyo (JP)

(21) Appl. No.: 16/415,222

(22) Filed: May 17, 2019

(30) Foreign Application Priority Data
May 18, 2018 (JP) 2018-095955

(51) Int. Cl. G06F 3/14; G09G 5/00

(52) U.S. Cl. CPC G06F 3/1454; G09G 5/006

(57) ABSTRACT

In an image display system provided with first to third projectors, the first projector displays a first image, and transmits first image information corresponding to the first image to the second and third projectors. The second and third projectors display the first image based on the first image information. Further, when the second projector receives an instruction of switching an image source while displaying the first image, the second projector displays a second image and transmits second image information corresponding to the second image to the first and third projectors. The first and third projectors display the second image based on the second image information.

The present application is based on, and claims priority from JP Application Serial Number 2018-095955, filed May 18, 2018, the disclosure of which is hereby incorporated by reference herein in its entirety.

### BACKGROUND

### 1. Technical Field

The present disclosure relates to an image display system, an image display device and a method of controlling an image display system.

### 2. Related Art

In an image display system having a plurality of image display devices (e.g., projectors) coupled to each other via a network or the like, there is known a technology of making one of the image display devices display an image currently displayed by another of the image display devices to thereby share the image with the plurality of image display devices (see, e.g., JP-A-2008-147846 (Document 1)). In the conference system described in Document 1, the projector acting as a server projects an image corresponding to image data received from a terminal device as an image source, and at the same time, transmits the image data to another projector to make the another projector also project the same image.

However, in such an image display system as described above, in the case of changing the shared image to an image of an image source coupled to another image display device, it is necessary for the user to perform an operation for switching the server, and at the same time perform an operation of selecting an intended image source in the image display device to newly become the server. Therefore, there is a problem that the procedure to be performed by the user is cumbersome since the two operations described above are necessary in the case in which a change of a shared image is accompanied by a change of the server.

### SUMMARY

An image display system according to an aspect of the present disclosure includes a first image display device and a second image display device, the first image display device includes a first display section configured to display a first image, a first communication section configured to transmit first image information corresponding to the first image to the second image display device, and a first control section configured to control an operation of the first display section and the first communication section, the second image display device includes a second communication section configured to receive the first image information, a second display section configured to display the first image based on the first image information, a second control section configured to control an operation of the second display section and the second communication section, and a reception section configured to receive an instruction of switching an image source, and when the reception section receives the instruction while the second display section displays the first image, the second control section makes the second display section display a second image, and makes the second communication section transmit second image information corresponding to the second image to the first image display device, the first communication section receives the second image information, and the first control section makes the first display section display the second image based on the second image information.

In the image display system described above, when the reception section receives the instruction while the second display section displays the first image, the second control section may perform a request to change a transmission source of image information to the first image display device, and when the request is allowed by the first image display device, the second control section may make the second display section display the second image, and may make the second transmission section transmit the second image information to the first image display device.

In the image display system described above, the second control section may make the second display section continue to display the first image when the request is rejected by the first image display device.

In the image display system described above, the reception section may receive an input operation by a user as the instruction of switching the image source.

In the image display system described above, the reception section may be the second communication section, and may receive the instruction of switching the image source with communication.

In the image display system described above, there may further be provided with a third image display device, the first image display device may transmit the first image information from the first communication section to the second image display device and the third image display device, the second image display device and the third image display device may display the first image based on the first image information, and when the reception section receives the instruction while the second image display device displays the first image, the second control section may make the second display section display the second image, and may make the second communication section transmit the second image information to the first image display device and the third image display device, and the first image display device and the third image display device may display the second image based on the second image information.

An image display device according to an aspect of the present disclosure includes a communication section configured to receive first image information transmitted from another image display device, a display section configured to display a first image based on the first image information, a control section configured to control an operation of the display section and the communication section, and a reception section configured to receive an instruction of switching an image source, and when the reception section receives the instruction while the display section displays the first image, the control section makes the display section display a second image, and makes the second communication section transmit second image information corresponding to the second image to the other image display device.

In the image display device described above, when the reception section receives the instruction while the display section displays the first image, the control section may perform a request to change a transmission source of image information to the other image display device, and when the request is allowed by the other image display device, the control section may make the display section display the second image, and may make the transmission section transmit the second image information to the other image display device.

In the image display device described above, the control section may make the display section continue to display the first image when the request is rejected by the other image display device.

In the image display device described above, the reception section may receive an input operation by a user as the instruction of switching the image source.

In the image display device described above, the reception section may be the communication section, and may receive the instruction of switching the image source with communication.

A method of controlling an image display system according to an aspect of the present disclosure is a method of controlling an image display system provided with a first image display device and a second image display device, the method including displaying a first image and transmitting first image information corresponding to the first image to the second image display device by the first image display device, displaying, by the second image display device, the first image based on the first image information, and when the second image display device receives an instruction of switching an image source while displaying the first image, displaying a second image and transmitting second image information corresponding to the second image to the first image display device, and displaying, by the first image display device, the second image based on the second image information.

In the method of controlling an image display system described above, when the second image display device receives the instruction while displaying the first image, the second image display device may perform a request to change a transmission source of image information to the first image display device, and when the request is allowed by the first image display device, the second image display device may display the second image, and may transmit the second image information to the first image display device.

In the method of controlling an image display system described above, the second image display device may continue to display the first image when the request is rejected by the first image display device.

In the method of controlling an image display system described above, the second image display device may receive an input operation by a user as the instruction of switching the image source.

In the method of controlling an image display system described above, the second image display device may receive the instruction of switching the image source with communication.

In the method of controlling an image display system described above, the image display system may further include a third image display device, the first image display device may transmit the first image information to the second image display device and the third image display device, the second image display device and the third image display device may display the first image based on the first image information, and when the second image display device receives the instruction while displaying the first image, the second image display device may display the second image, and may transmit the second image information to the first image display device and the third image display device, and the first image display device and the third image display device may display the second image based on the second image information.

### BRIEF DESCRIPTION OF THE DRAWINGS

FIG. 1 is an explanatory diagram showing a schematic configuration of an image display system.

FIG. 2 is a block diagram showing a schematic configuration of a projector.

FIG. 3 is a block diagram showing a schematic configuration of an image projection section provided to the projector.

FIG. 4 is an explanatory diagram for explaining an operation of the image display system.

FIG. 5 is an explanatory diagram for explaining an operation of the image display system.

FIG. 6 is a flowchart for explaining an operation of the projector when functioning as a server projector.

FIG. 7 is a flowchart for explaining an operation of the projector when functioning as a client projector.

FIG. 8 is a block diagram showing a schematic configuration of a projector according to a modified example.

### DESCRIPTION OF EXEMPLARY EMBODIMENTS

An image display system according to the present embodiment will hereinafter be described with reference to the drawings.

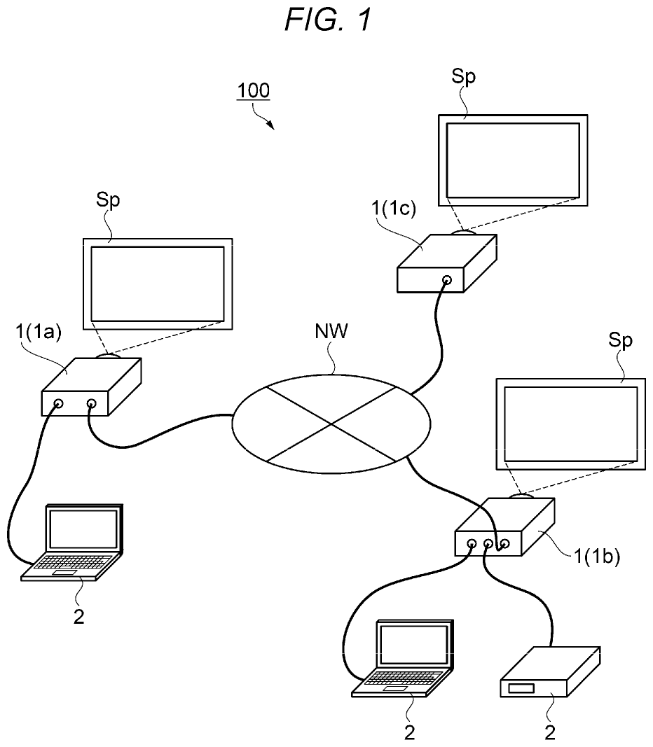

FIG. 1 is an explanatory diagram showing a schematic configuration of the image display system 100 according to the present embodiment.

As shown in FIG. 1, the image display system 100 is configured including a plurality of projectors 1 as image display devices coupled to each other via a network NW. Each of the projectors 1 projects to display an image on a projection surface Sp as a display surface such as a screen or a wall surface. In an example shown in FIG. 1, the image display system 100 is provided with the three projectors 1, namely the projectors 1a, 1b and 1c.

To each of the projectors 1, there is coupled an image supply device 2 located in the outside such as a computer or a variety of video equipment as needed. The image supply device 2 is a supply source of the image information, and is also called an image source. The projector 1 is capable of projecting an image corresponding to the image information supplied from the image supply device 2 connected to the projector 1. Further, in the image display system 100 according to the present embodiment, it is arranged that all of the projectors 1 can also display the same image by one of the projectors 1 transmitting the image information to the rest of the projectors 1 via the network NW. Hereinafter, the operation of the plurality of projectors 1 displaying the same image is also expressed as “sharing an image.”

It should be noted that in the present embodiment, there is assumed a configuration in which the projectors 1 are disposed at places distant from each other, and are operated by users located adjacent to the respective projectors 1, but it is also possible to adopt a configuration in which all of the projectors 1 are disposed relatively close to each other, and one user operates all of the projectors 1.

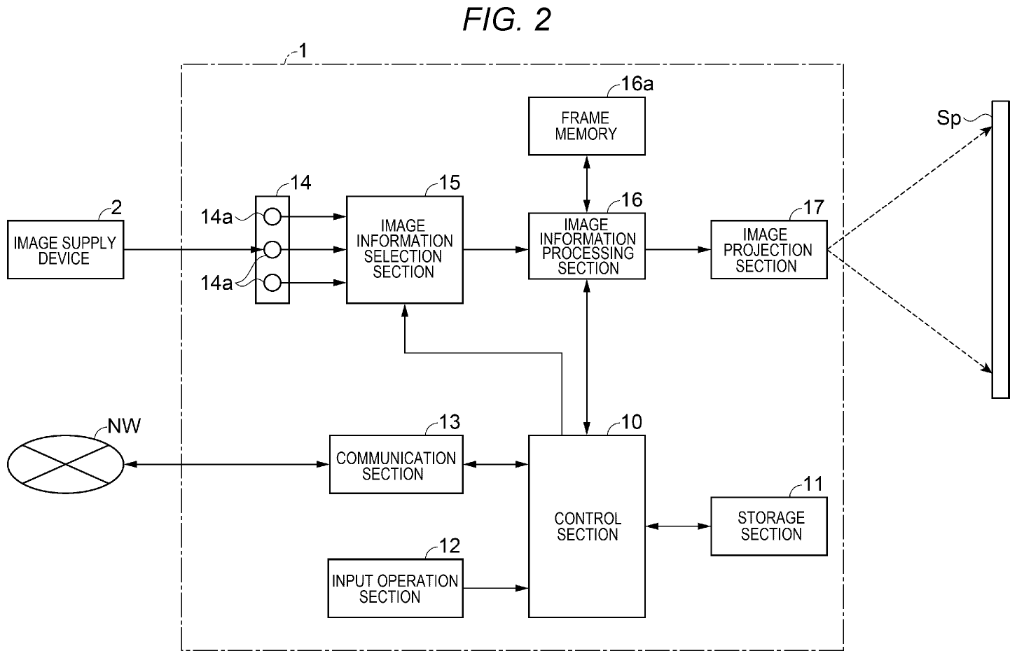

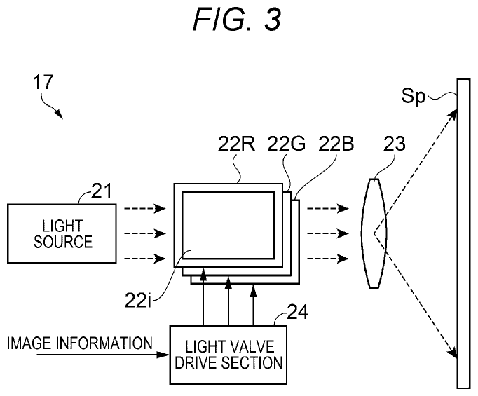

FIG. 2 is a block diagram showing a schematic configuration of the projector 1, and FIG. 3 is a block diagram showing a schematic configuration of an image projection section 17 provided to the projector 1.

As shown in FIG. 2, the projector 1 is configured integrally including a control section 10, a storage section 11, an input operation section 12, a communication section 13, an image information input section 14, an image information selection section 15, an image information processing section 16, and an image projection section 17 as a display section. The projector 1 projects an image from the image projection section 17 on the projection surface Sp based on the image information input from the image supply device 2 to the image information input section 14.

The control section 10 is configured including one processor or a plurality of processors, and operates in accordance with a control program (not shown) stored in the storage section 11 to thereby integrally control the operation of the projector 1.

The storage section 11 is configured including memory devices such as a random access memory (RAM) and a read only memory (ROM). The RAM is used for a temporary storage of a variety of types of data, and the ROM stores the control program for controlling the operation of the projector 1, a variety of types of configuration information and so on. Further, the storage section 11 stores connection information (e.g., an IP address) for connecting the projector 1 to another projector 1. The connection information is information set by the user, or information detected automatically.

The input operation section 12 is provided with a plurality of operation keys for the user to make a variety of instructions to the projector 1. As the operation keys provided to the input operation section 12, there are cited a “power key” for switching between ON and OFF (standby) of the power, a “menu key” for displaying a menu image for performing a variety of types of settings, “directional keys” for selecting items in the menu image, an “input selection key” for selecting the image source, and so on. When the user operates the various operation keys of the input operation section 12, the input operation section 12 receives the operation, and then outputs an operation signal corresponding to the content of the operation to the control section 10. It should be noted that it is also possible to adopt a configuration of using a remote controller (not shown) capable of a remote operation as the input operation section 12. In this case, the remote controller transmits an operation signal of an infrared ray corresponding to the operation content by the user, and then a remote control signal receiving section not shown receives the operation signal to transmit the operation signal to the control section 10.

The communication section 13 is coupled to external devices such as other projectors 1 via the network NW, and performs transmission/reception of the information with these devices based on the control by the control section 10. Further, in the case in which the image information is input to the communication section 13 via the network NW, the image information input is output by the control section 10 to the image information processing section 16. The coupling between the communication section 13 and the external devices is not limited to wired connection, but can also be wireless coupling.

The image information input section 14 is configured including a plurality of input terminals 14a for coupling the image information section 14 to the image supply device 2. As the input terminal 14a provided to the image information input section 14, there are cited an HDMI terminal for coupling the projector 1 to video equipment or a computer compatible with HDMI (high definition multimedia interface, a registered trademark), a miniature D-Sub 15-pin terminal (hereinafter also referred to as a “computer terminal”) for inputting an analog RGB signal mainly from a computer, a composite terminal (hereinafter also referred to as a “video terminal”) for inputting a composite signal mainly from video equipment, and so on. The image information input to the input terminal 14a of the image information input section 14 is output to the image information selection section 15.

The image information selection section 15 selects one or more of the input terminals 14a provided to the image information input section 14, and then outputs the image information input to the input terminal 14a thus selected to the image information processing section 16 based on the control by the control section 10. It should be noted that in the case in which the projector 1 displays the image based on the image information input to the communication section 13 via the network NW, the image information selection section 15 does not select any input terminal 14a, and does not output the image information.

The image information processing section 16 is coupled to a frame memory 16a formed of a RAM and so on. The image information processing section 16 converts the image information input from the image information selection section 15 or the control section 10 into the image information in a predetermined format, and then performs a variety of processes on the image information thus converted based on the control by the control section 10. Specifically, the image information processing section 16 stores the image information which has been converted into one in the predetermined format in the frame memory 16a frame (screen) by frame, and at the same time, performs, for example, a process of correcting the color and the brightness of the image, a process of correcting a distortion of the shape of the image, a process of superimposing an OSD (on-screen display) image such as a menu image or a message image on an image, and the like on the image information thus stored. The image information processing section 16 outputs the image information on which the process has been performed to a light valve drive section 24 (see FIG. 3) of the image projection section 17. Further, the image information processing section 16 is capable of retrieving the image information stored in the frame memory 16a and then outputting the image information to the control section 10 based on the control of the control section 10.

It should be noted that the image information input section 14, the image information selection section 15 and the image information processing section 16 can be constituted by one processor, a plurality of processors or the like, or can also be configured including a dedicated processing device such as an ASIC (application specific integrated circuit) or an FPGA (field programmable gate array).

As shown in FIG. 3, the image projection section 17 is configured including a light source 21, three liquid crystal light valves 22R, 22G, and 22B as light modulation devices, a projection optical system 23, a light valve drive section 24 and so on. The image projection section 17 modulates the light emitted from the light source 21 with the liquid crystal light valves 22R, 22G, and 22B to thereby form image light, and then projects the image light from the projection optical system 23 including at least one of a lens and a mirror to thereby display the image on the projection surface Sp. Display of the image by the image projection section 17 is controlled by the control section 10 via the image information selection section 15 and the image information processing section 16.

The light source 21 is configured including a discharge type light source lamp such as a super high-pressure mercury lamp or a metal halide lamp, or a solid-state light source such as a light emitting diode or a semiconductor laser. The light emitted from the light source 21 is converted into the light having a substantially uniform intensity distribution by an integrator optical system not shown, and is then separated into colored light components of red (R), green (G), and blue (B), the three primary colors of light, by a color separation optical system not shown, and then the colored light components enter the liquid crystal light valves 22R, 22G, and 22B, respectively.

The liquid crystal light valves 22R, 22G, and 22B are each formed of a transmissive liquid crystal panel having a liquid crystal material encapsulated between a pair of transparent substrates, and so on. The liquid crystal panels are each provided with a rectangular pixel area 22i constituted by a plurality of pixels arranged in a matrix, and are each arranged so that a drive voltage can be applied to the liquid crystal material pixel by pixel.

The light valve drive section 24 forms an image in the pixel area 22i of each of the liquid crystal light valves 22R, 22G and 22B. Specifically, the light valve drive section 24 applies the drive voltages corresponding to the image information input from the image information processing section 16 to the respective pixels in the pixel area 22i to thereby set the pixels to respective light transmittances corresponding to the image information. The light emitted from the light source device 21 is transmitted through the pixel area 22i of each of the liquid crystal light valves 22R, 22G and 22B to thereby be modulated pixel by pixel, and thus the image light corresponding to the image information is formed for each of the colored light beams. The colored light beams as the image light of the respective colors thus formed are combined with each other pixel by pixel by a color composition optical system not shown to turn to the image light representing a color image, and the image light is then projected on the projection surface Sp by the projection optical system 23 in an enlarged manner. As a result, on the projection surface Sp, there is displayed an image based on the image information.

Then, an operation of the image display system 100 will be described.

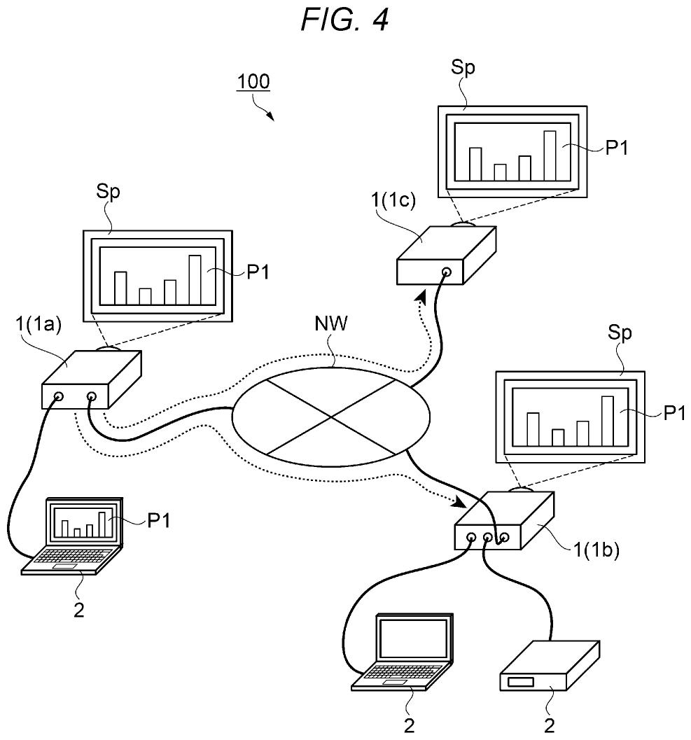

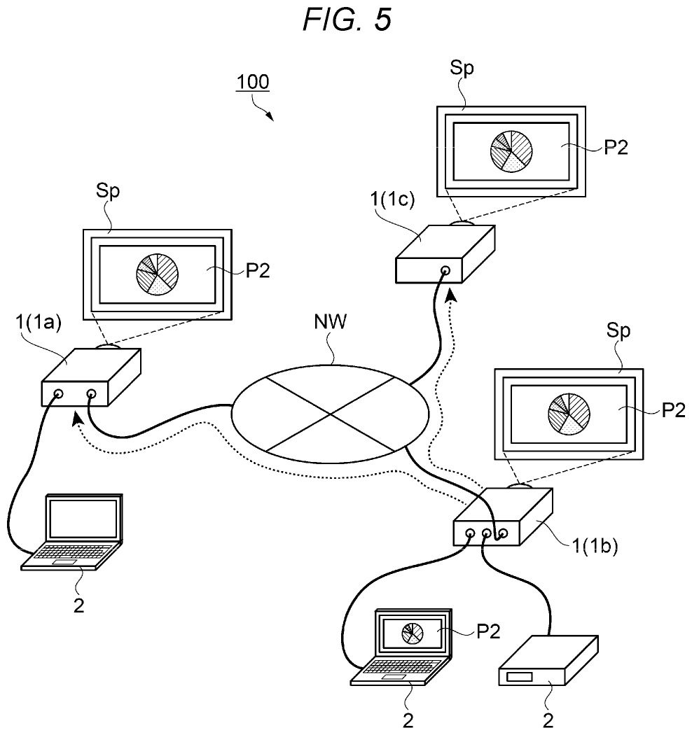

FIG. 4 and FIG. 5 are explanatory diagrams for explaining the operation of the image display system 100.

In the projector 1 according to the present embodiment, it is possible for the user to select the intended image source by operating the input selection key provided to the input operation section 12. In the input selection key of the present embodiment, it is arranged that four alternatives of “HDMI,” “computer,” “video” and “screen sharing,” for example, can be selected. In the case in which “HDMI,” “computer” or “video” is selected from these alternatives, the control section 10 makes the image information selection section 15 select the HDMI terminal, the computer terminal or the video terminal corresponding respectively thereto, and makes the image information processing section 16 output the image information input to the respective terminals. In contrast, in the case in which “screen sharing” is selected as the image source, the control section 10 does not output the image information from the image information selection section 15, but outputs the image information which is input to the communication section 13 from another projector 1 via the network NW, to the image information processing section 16.

For example, in the configuration shown in FIG. 1, in the case in which “computer” is selected by the input selection key of the projector 1a, the projector 1a projects the same image as the image displayed on a monitor of the image supply device 2 (the computer) coupled to the computer terminal of the projector 1a based on the image information input from the computer. Then, when the user instructs start of the screen sharing to the projector 1a, and further designates the projectors 1b, 1c as the transmission destinations of the image information, the projector 1a starts transmission of the image information corresponding to the image currently projected by the projector 1a to the projectors 1b, 1c thus designated. It should be noted that the instruction of start of the screen sharing is performed by selecting an item for starting the screen sharing in, for example, the menu screen displayed at the startup or the menu screen displayed when operating the menu key of the input operation section 12.

Here, when “screen sharing” is selected as the image source by the input selection key of another projector 1b, 1c, the control section 10 of the projector 1b, 1c outputs the image information input to the communication section 13 from the projector 1a via the network NW, to the image information processing section 16. As a result, as shown in FIG. 4, the same image P1 as the image (hereinafter also referred to as a “first display image”) P1 currently projected by the projector 1a is also projected from the projector 1b, 1c.

It should be noted that hereinafter, among the plurality of projectors 1 sharing the screen, one projector 1 which transmits the image information to the rest of the projectors 1 as the transmission source of the image information is also referred to as a “server projector” or a “server.” Further, the projector 1 in which “screen sharing” is selected as the image source, namely another projector 1 which receives the image information from the server projector to project the same image as that of the server projector, is also referred to as a “client projector” or a “client.” Each of the projectors 1 can act as either of the server projector and the client projector, and in the storage section 11 of each of the projectors 1, there is stored the configuration information representing what projector 1 is currently acting as the server projector and what projector 1 is currently acting as the client projector.

In the image display system 100 according to the present embodiment, in the case of performing the operation of switching the image source with the input selection key with respect to one client projector when the screen is shared with the plurality of projector 1, the client projector displays the image of the image source thus switched, and at the same time, newly becomes the server projector to transmit the image information corresponding to this image to the other projectors 1.

For example, in the case in which the projector 1a is the server projector, and the projectors 1b, 1c are the client projectors as shown in FIG. 4, the projector 1a projects the first display image P1 based on the image information supplied from the image supply device 2 coupled to the projector 1a. Further, the projector 1a transmits the image information corresponding to the first display image P1 to the projectors 1b, 1c. The projectors 1b, 1c as the client projectors receive the image information thus transmitted to project the first display image P1 based on the image information. In other words, there is created the state in which the three projectors 1 share the first display image P1.

Here, when the user performs the operation of switching the image source, for example, from “screen sharing” to “computer” on the projector 1b as one of the client projectors, the projector 1b transmits a request command for requesting a change of the server to the projector 1a as the server projector. Then, when the projector 1a receives the request command, the projector 1a transmits a notification command for giving a notification of the change of the server to the projectors 1b, 1c as the client projectors.

When the projector 1b receives the notification command, the projector 1b determines that the change of the server has been allowed, and thereafter acts as the server projector. In other words, as shown in FIG. 5, the projector 1b displays a second display image P2 based on the image information supplied from the image source thus changed by the user, and at the same time, transmits the image information corresponding to the second display image P2 to the other projectors 1a, 1c.

The projector 1a which has been the server projector until then turns to the client projector after transmitting the notification command, and projects the second display image P2 based on the image information transmitted from the projector 1b as the new server projector. Further, the projector 1c continues the client projector, but performs a process of changing the server projector from the projector 1a to the projector 1b based on the notification command from the projector 1a, and thereafter projects the second display image P2 based on the image information transmitted from the projector 1b. In other words, there is created the state in which the three projectors 1 share the second display image P2. It should be noted that in the case in which the change of the server is rejected by the projector 1a, the projector 1b continuously acts as the client projector. In other words, there is continued the state in which the three projectors 1 display the first display image P1.

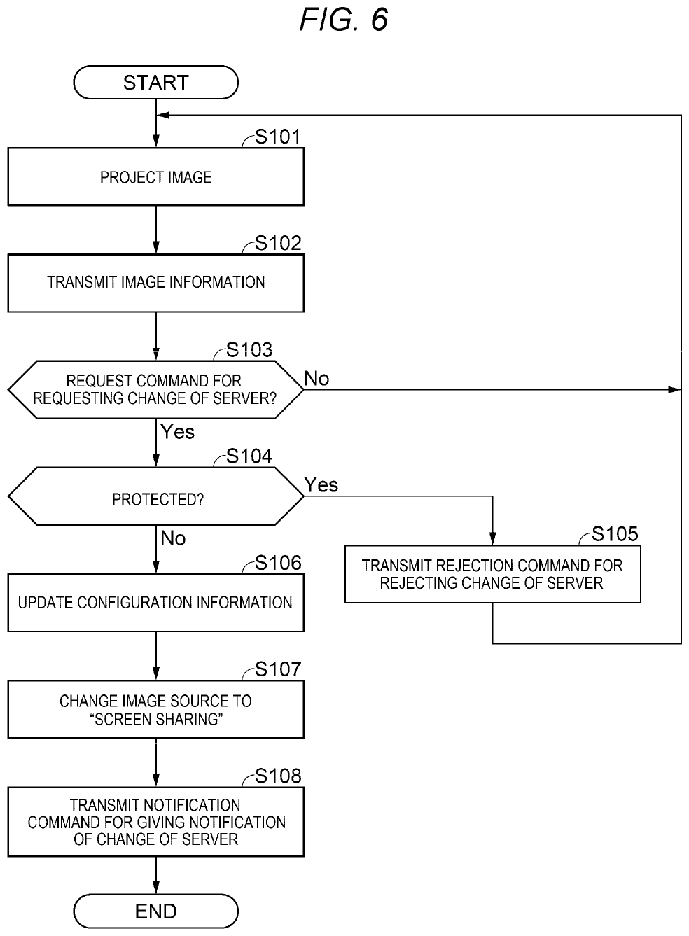

FIG. 6 is a flowchart for explaining an operation of the projector 1 when the projector 1 functions as the server projector.

As shown in FIG. 6, in the step S101, the control section 10 of the server projector projects the image from the image projection section 17 based on the image information supplied from the image supply device 2. Then, in the step S102, the control section 10 obtains the image information which is stored in the frame memory 16a, and on which a variety of correction processes have not yet been performed, from the image information processing section 16, then converts the image information into the image information in the predetermined format, and then transmits the result from the communication section 13 toward the client projectors.

In the step S103, the control section 10 of the server projector determines whether or not the request command for requesting the change of the server projector has been transmitted from the client projector. Further, in the case in which the request command has been transmitted, the control section 10 makes the transition of the process to the step S104, and in the case in which the request command has not been transmitted, the control section 10 returns the process to the step S101 to continue the projection of the image and the transmission of the image information.

In the case in which the communication section 13 has received the request command transmitted from the client projector, and the transition of the process to the step S104 has been performed, the control section 10 of the server projector refers to the configuration information stored in the storage section 11 to determine whether or not protection setting for protecting the server projector has been made. The protection setting is setting for preventing the server projector from being involuntarily changed, and in the case in which the user does not want an unintended change of the server projector, it is possible for the user to make the protection setting in advance by performing a predetermined procedure in accordance with the menu screen displayed when operating the menu key. The control section 10 makes the transition of the process to the step S105 in the case in which the protection setting has been made, or makes the transition of the process to the step S106 in the case in which the protection setting has not been made.

In the case in which the protection setting has been made, and therefore, the transition of the process to the step S105 has been made, the control section 10 of the server projector transmits a rejection command for rejecting the change of the server projector to the client projector which has transmitted the request command.

In contrast, in the case in which the protection setting has not been made, and therefore, the transition of the process to the step S106 has been made, the control section of the server projector updates the configuration information setting the projector 1 which has transmitted the request command as a new server projector, and setting itself as the client projector. Further, in the step S107, the control section 10 changes the image source to “screen sharing.”

Then, in the step S108, the control section 10 transmits the notification command for giving the notification that the server projector is changed to all other projectors 1, and then terminates the flow. The notification command also includes the update information updated in the step S106. Thereafter, the projector 1 acts as the client projector, and projects the image based on the image information transmitted from the new server projector.

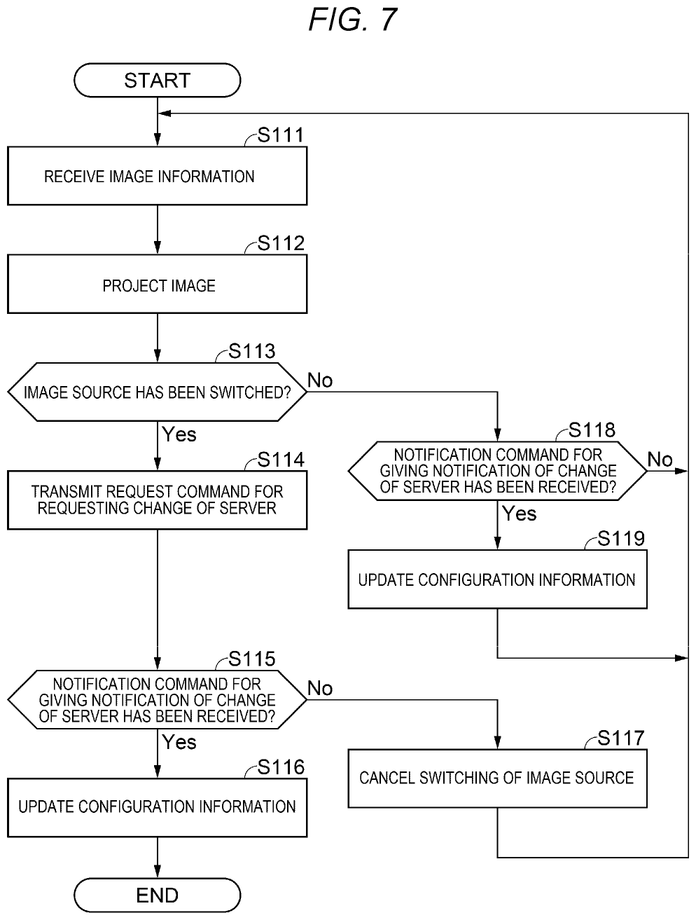

FIG. 7 is a flowchart for explaining an operation of the projector 1 when the projector 1 functions as the client projector.

As shown in FIG. 7, in the step S111, the control section 10 of the client projector receives the image information transmitted from the server projector via the communication section 13. Then, in the step S112, the control section 10 outputs the image information thus received to the image information processing section 16, and projects the image based on the image information from the image projection section 17.

In the step S113, the control section 10 of the client projector determines whether or not the input selection key of the input operation section 12 has been operated by the user and thus the image source has been switched, namely whether or not the image source other than “screen sharing” has been selected. Then, in the case in which the image source has been switched to the image source other than “screen sharing,” the control section 10 makes the transition of the process to the step S114, and in the case in which the image source currently selected is not changed but is kept in “screen sharing,” the control section 10 makes the transition of the process to the step S118.

In the case in which the image source has been switched to make the transition of the process to the step S114, and therefore, the control section 10 of the client projector transmits the request command for requesting the change of the server projector to the current server projector.

In the step S115, the control section 10 of the client projector determines whether or not the notification command has been transmitted from the server projector. Then, the control section 10 makes the transition of the process to the step S116 in the case in which the control section 10 has received the notification command, or makes the transition of the process to the step S117 in the case in which the control section 10 has received the rejection command.

In the case in which the notification command has been received, and thus, the transition of the process to the step S116 has been made, the control section 10 of the client projector determines that the change to the server projector has been allowed, updates the configuration information setting itself as the server projector, and setting the other projectors 1 as the client projectors, and then terminates the flow. Thereafter, the projector 1 acts as the server projector, and starts the transmission of the image information to the client projectors.

In the case in which the rejection command has been received and therefore the transition of the process to the step S117 has been made, the control section 10 of the client projector cancels the switching of the image source to restore the image source to “screen sharing.” Then, the control section 10 returns the process to the step S111 to continue the action as the client projector. Specifically, the control section 10 projects the image based on the image information from the server projector continuously from the image projection section 17.

In the case in which the change of the image source does not occur in the step S113 and thus the transition of the process to the step S118 has been made, the control section 10 of the client projector determines whether or not the notification command has been transmitted from the server projector. It should be noted that the case in which the notification command is transmitted despite the request command is not transmitted by itself is the case in which another client projector has transmitted the request command to the server projector, and the request has been allowed. In the case in which the notification command has been received, the control section 10 makes the transition of the process to the step S119, and in the case in which the notification command has not been received, the control section 10 returns the process to the step S111 to continue the reception of the image information and the projection of the image.

In the case in which the notification command has been received and thus the transition of the process to the step S119 has been made, the control section 10 of the client projector also updates the own update information, and returns the process to the step S111 based on the configuration information included in the notification command. Further, thereafter, the projector 1 projects the image based on the image information transmitted from the new server projector.

As described hereinabove, according to the image display system 100, the projector 1 and the method of controlling these related to the present embodiment, the following advantages can be obtained.

(1) According to the present embodiment, when the input selection key is operated and the switching of the image source is instructed in the client projector which projects the image based on the image information transmitted from the server projector, the client projector newly turns to the server projector, and becomes in the state of sharing the image of the image source having been switched with the other projectors 1. In other words, by the user operating the input selection key of the client projector, both of the change of the server projector and the change of the image to be shared are performed, and therefore, the procedure of the user becomes easy.

(2) According to the present embodiment, when the input selection key is operated, the client projector requests the change of the server projector to the current server projector, and in the case in which the request has been allowed, the client projector turns to the server projector to transmit the image information to the other projectors 1. Therefore, it becomes possible to prevent the display content of the projector 1 which has been the server projector until then from being involuntarily switched.

(3) According to the present embodiment, even in the case in which the input selection key has been operated, the client projector continues to display the image having been displayed until then in the case in which the request to change the server projector is rejected, and therefore, it becomes possible to keep the state in which the projectors 1 share the same image.

(4) According to the present embodiment, since there is adopted the configuration in which the image source is switched by operating the input selection key of the client projector, it becomes possible for the user to easily change the image to be shared.

It should be noted that in the embodiment described above, in the case in which the projector 1a acting as the server projector is defined as a first image display device, the projector 1b as the client projector corresponds to a second image display device, and the projector 1c as the other client projector corresponds to a third image display device. In this case, the control section 10, the communication section 13 and the image projection section 17 of the projector 1a correspond respectively to a first control section, a first communication section and a first display section, and the control section 10, the communication section 13 and the image projection section 17 of the projector 1b correspond respectively to a second control section, a second communication section and a second display section. Further, the first display image P1 corresponds to a first image, and the image information corresponding to the first display image P1 corresponds to first image information. Further, the second display image P2 corresponds to a second image, and the image information corresponding to the second display image P2 corresponds to second image information. Further, the input selection key of the input operation section 12 corresponds to a reception section, and the operation of the input selection key by the user corresponds to an “instruction of switching the image source.”

### MODIFIED EXAMPLES

Further, the embodiment described above can also be modified as follows.

In the embodiment described above, the configuration of switching between the image sources with the input selection key can also be a configuration of sequentially switching between the image sources every time the input selection key is operated. Further, in the case in which the input selection key has been operated, it is possible to arrange that a list of the image sources is displayed as the OSD image to allow the user to select the intended image source from the list. Further, it is also possible to adopt a configuration of disposing a plurality of input selection keys corresponding respectively to the image sources different from each other in the input operation section 12, and perform switching to the image source corresponding to the input selection key thus operated. Further, in the case in which the projector 1 has an interactive function of detecting the operation of the user performed on the projection surface Sp, and performing an action corresponding to the position of the operation, it is also possible to arrange that the image source is switched by the interactive function.

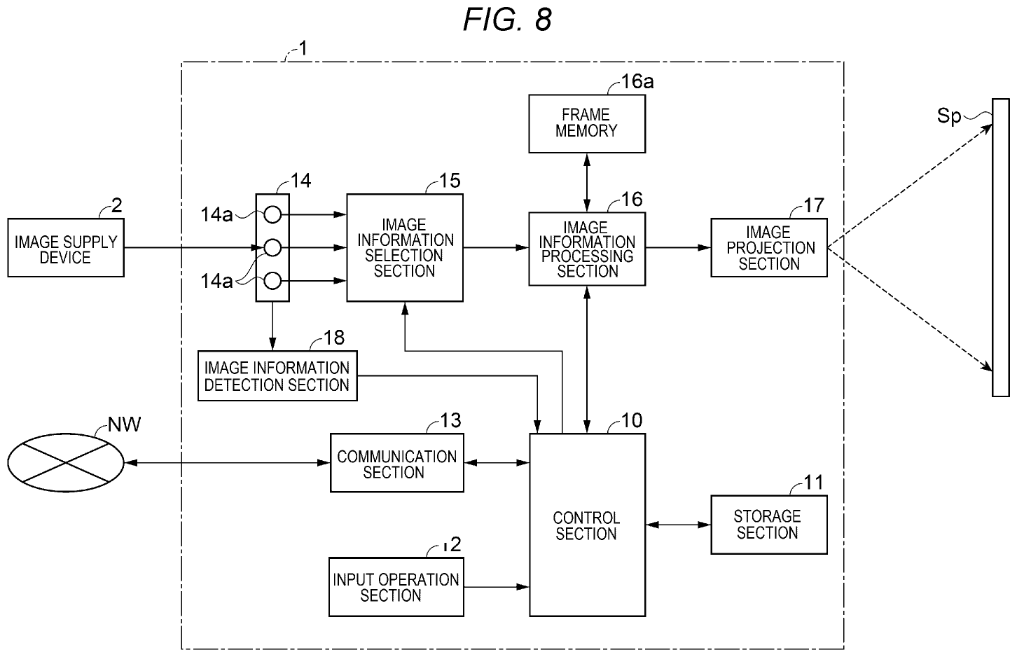

Further, it is also possible to adopt a configuration of switching between the image sources in the case in which the input of the image information to the input terminal 14a is started. For example, as shown in FIG. 8, it is also possible to arrange that an image information detection section 18 for detecting an input of the image information to each of the input terminals 14a is further provided, and the control section 10 makes the image information selection section 15 select the input terminal 14a in which the input of the image information has been detected based on the detection result of the image information detection section 18. In this case, the operation of starting the output of the image information from the image supply device 2, or the operation of coupling the image supply device 2 currently outputting the image information to the input terminal 14a corresponds to the “instruction of switching the image source.”

Further, in the embodiment described above, there is described the configuration of changing the server projector by operating the input selection key of the projector 1 which should be changed next to the server projector to thereby switch between the image sources of the projector 1, but this configuration is not a limitation. For example, it is also possible to arrange that the image source can be switched by another projector 1 connected via the network NW, a control device not shown connected via the network NW or the like. Specifically, as shown in FIG. 4, in the case in which the projector 1a is the server projector, and the projectors 1b, 1c are the client projectors, it is also possible to arrange that the projector 1a or the projector 1c transmits the control command for switching the image source to the projector 1b via the network NW based on the input operation by the user to the input operation section 12. Then, the projector 1b receives the control command thus transmitted with the communication section 13, and then switches the image source based on the control command thus received. According to this configuration, it becomes possible to perform the instruction for switching the server projector from a device other than the projector 1 which should be changed next to the server projector. It should be noted that in this case, the control command for switching the image source corresponds to the “instruction of switching the image source,” and the communication section 13 for receiving the control command corresponds to the reception section.

In the embodiment described above, it is arranged that the client projector transmits the request command to the server projector in accordance with the switching operation of the image source, and in the case in which the request is rejected, the client projector cancels the switching of the image source, and continues the screen sharing as the client projector, but this configuration is not a limitation. For example, it is also possible to arrange that the client projector terminates the screen sharing to display the image of the image source having been switched in the case in which the request command has been rejected.

In the embodiment described above, there is shown the example in which the image display system 100 is provided with the three projectors 1, but the number of the projectors 1 is not limited to three, and can also be two, or four or more.

Although in the embodiment described above, the transmissive liquid crystal light valves 22R, 22G, and 22B are used as the light modulation devices, it is also possible to use reflective light modulation devices such as reflective liquid crystal light valves. Further, it is also possible to use a digital mirror device or the like for modulating the light emitted from the light source 21 by controlling the emission direction of the incident light for every micromirror as a pixel. Further, the configuration of providing the plurality of light modulation devices for the respective colored light beams is not a limitation, but it is also possible to adopt a configuration of modulating the plurality of colored light beams with a single light modulation device in a time-sharing manner.

Although in the embodiment described above, the projector 1 is described as an example of the image display device, the image display device is not limited to the projector 1, but can also be other image display devices such as a liquid crystal display or an organic EL display.

Hereinafter, the contents derived from the embodiment will be described.

The image display system is provided with a first image display device and a second image display device, the first image display device includes a first display section configured to display a first image, a first communication section configured to transmit first image information corresponding to the first image to the second image display device, and a first control section configured to control an operation of the first display section and the first communication section, the second image display device includes a second communication section configured to receive the first image information, a second display section configured to display the first image based on the first image information, a second control section configured to control an operation of the second display section and the second communication section, and a reception section configured to receive an instruction of switching an image source, and in a case in which the reception section receives the instruction while the second display section displays the first image, the second control section makes the second display section display a second image, and makes the second communication section transmit second image information corresponding to the second image to the first image display device, the first communication section receives the second image information, and the first control section makes the first display section display the second image based on the second image information.

According to this configuration, the image display system is switched from a state of sharing the first image based on the first image information transmitted from the first image display device to a state of sharing the second image based on the second image information transmitted from the second image display device in the case in which the reception section of the second image display device has received the instruction of switching the image source. In other words, by the user performing the operation of switching the image source of the second image display device, both of the change of the transmission source of the image information and the change of the image to be shared are performed, and therefore, the procedure of the user becomes easy.

In the image display system described above, in the case in which the reception section receives the instruction while the second display section displays the first image, the second control section may perform a request to change a transmission source of image information to the first image display device, and in a case in which the request is allowed by the first image display device, the second control section may make the second display section display the second image, and may make the second transmission section transmit the second image information to the first image display device.

According to this configuration, the second image display device requests the change of the transmission source to the first image display device in the case of receiving the instruction of switching the image source, and then transmits the second image information to the first image display device in the case in which this request is allowed. Therefore, it becomes possible to prevent the display content of the first image display device from being involuntarily switched to the second image.

In the image display system described above, the second control section may make the second display section continue to display the first image in a case in which the request is rejected by the first image display device.

According to this configuration, even in the case in which the second image display device has received the instruction of switching the image source, the second image display device continues to display the first image in the case in which the request to change the transmission source is rejected by the first image display device, and therefore, it becomes possible to keep the state of sharing the same image with the first image display device and the second image display device.

In the image display system described above, the reception section may receive an input operation by a user as the instruction of switching the image source.

According to this configuration, it becomes possible for the user to easily change the image to be shared by performing the input operation of switching between the image sources to the second image display device.

In the image display system described above, the reception section may be the second communication section, and may receive the instruction of switching the image source with communication.

According to this configuration, since the second communication section receives the instruction of switching the image source, it becomes possible to perform the instruction from an external device (e.g., the first image display device) capable of communicating with the second image display device via the second communication section.

In the image display system described above, there may further be provided with a third image display device, the first image display device may transmit the first image information from the first communication section to the second image display device and the third image display device, the second image display device and the third image display device may display the first image based on the first image information, and in a case in which the reception section receives the instruction while the second image display device displays the first image, the second control section may make the second display section display the second image, and may make the second communication section transmit the second image information to the first image display device and the third image display device, and the first image display device and the third image display device may display the second image based on the second image information.

According to this configuration, even in the case of sharing the image with three image display devices, it becomes possible to easily change the image to be shared.

The image display device includes a communication section configured to receive first image information transmitted from another image display device, a display section configured to display a first image based on the first image information, a control section configured to control an operation of the display section and the communication section, and a reception section configured to receive an instruction of switching an image source, and in a case in which the reception section receives the instruction while the display section displays the first image, the control section makes the display section display a second image, and makes the communication section transmit second image information corresponding to the second image to the other image display device.

According to this configuration, there occurs switching from a state of sharing the first image based on the first image information transmitted from the other image display device to a state of sharing the second image based on the second image information transmitted by itself in the case in which the reception section has received the instruction of switching the image source. In other words, by the user performing the operation of switching the image source, both of the change of the transmission source of the image information and the change of the image to be shared are performed, and therefore, the procedure of the user becomes easy.

In the image display device described above, in the case in which the reception section receives the instruction while the display section displays the first image, the control section may perform a request to change a transmission source of image information to the other image display device, and in a case in which the request is allowed by the other image display device, the control section may make the display section display the second image, and may make the transmission section transmit the second image information to the other image display device.

According to this configuration, the image display device requests the change of the transmission source to the other image display device in the case of receiving the instruction of switching the image source, and then transmits the second image information to the other image display device in the case in which this request is allowed. Therefore, it becomes possible to prevent the display content of the other image display device from being involuntarily switched to the second image.

In the image display device described above, the control section may make the display section continue to display the first image in a case in which the request is rejected by the other image display device.

According to this configuration, even in the case in which the image display device has received the instruction of switching the image source, the image display device continues to display the first image in the case in which the request to change the transmission source is rejected by the other image display device, and therefore, it becomes possible to keep the state of sharing the same image with the other image display device.

In the image display device described above, the reception section may receive an input operation by a user as the instruction of switching the image source.

According to this configuration, it becomes possible for the user to easily change the image to be shared by performing the input operation of switching between the image sources to the image display device.

In the image display device described above, the reception section may be the communication section, and may receive the instruction of switching the image source with communication.

According to this configuration, since the communication section receives the instruction of switching the image source, it becomes possible to perform the instruction from an external device (e.g., the other image display device) with which the image display device can communicate via the communication section.

The method of controlling an image display system is a method of controlling an image display system provided with a first image display device and a second image display device, the method including the steps of displaying a first image and transmitting first image information corresponding to the first image to the second image display device by the first image display device, displaying, by the second image display device, the first image based on the first image information, and in a case in which the second image display device receives an instruction of switching an image source while displaying the first image, displaying a second image and transmitting second image information corresponding to the second image to the first image display device, and displaying, by the first image display device, the second image based on the second image information.

According to this configuration, the image display system is switched from a state of sharing the first image based on the first image information transmitted from the first image display device to a state of sharing the second image based on the second image information transmitted from the second image display device in the case in which the second image display device has received the instruction of switching the image source. In other words, by the user performing the operation of switching the image source of the second image display device, both of the change of the transmission source of the image information and the change of the image to be shared are performed, and therefore, the procedure of the user becomes easy.

In the method of controlling the image display system described above, in the case in which the second image display device receives the instruction while displaying the first image, the second image display device may perform a request to change a transmission source of image information to the first image display device, and in a case in which the request is allowed by the first image display device, the second image display device may display the second image, and may transmit the second image information to the first image display device.

According to this configuration, the second image display device requests the change of the transmission source to the first image display device in the case of receiving the instruction of switching the image source, and then transmits the second image information to the first image display device in the case in which this request is allowed. Therefore, it becomes possible to prevent the display content of the first image display device from being involuntarily switched to the second image.

In the method of controlling the image display system described above, the second image display device may continue to display the first image in a case in which the request is rejected by the first image display device.

According to this configuration, even in the case in which the second image display device has received the instruction of switching the image source, the second image display device continues to display the first image in the case in which the request to change the transmission source is rejected by the first image display device, and therefore, it becomes possible to keep the state of sharing the same image with the first image display device and the second image display device.

In the method of controlling the image display system described above, the second image display device may receive an input operation by a user as the instruction of switching the image source.

According to this configuration, it becomes possible for the user to easily change the image to be shared by performing the input operation of switching between the image sources to the second image display device.

In the method of controlling the image display system described above, the second image display device may receive the instruction of switching the image source with communication.

According to this configuration, since the instruction of switching the image source is received with the communication, it becomes possible to perform the instruction from an external device (e.g., the first image display device) capable of communicating with the second image display device.

In the method of controlling the image display system described above, the image display system may further include a third image display device, the first image display device may transmit the first image information to the second image display device and the third image display device, the second image display device and the third image display device may display the first image based on the first image information, and in a case in which the second image display device receives the instruction while displaying the first image, the second image display device may display the second image, and may transmit the second image information to the first image display device and the third image display device, and the first image display device and the third image display device may display the second image based on the second image information.

According to this configuration, even in the case of sharing the image with three image display devices, it becomes possible to easily change the image to be shared.

What is claimed is:

1. An image display system comprising:
a first image display device; and
a second image display device, wherein
the first image display device includes
a first display section configured to display a first image,
a first communication section configured to transmit first image information corresponding to the first image to the second image display device, and
a first control section configured to control an operation of the first display section and an operation of the first communication section,
the second image display device includes
a second communication section configured to receive the first image information,
a second display section configured to display the first image based on the first image information,
a second control section configured to control an operation of the second display section and an operation of the second communication section, and
a reception section configured to receive an instruction of switching an image source, and
when the reception section receives the instruction while the second display section displays the first image,
the second control section makes the second display section display a second image, and makes the second communication section transmit second image information corresponding to the second image to the first image display device,
the first communication section receives the second image information, and
the first control section makes the first display section display the second image based on the second image information.

2. The image display system according to claim 1, wherein
when the reception section receives the instruction while the second display section displays the first image, the second control section performs a request to change a transmission source of image information to the first image display device, and when the request is allowed by the first image display device, the second control section makes the second display section display the second image, and makes the second transmission section transmit the second image information to the first image display device.

3. The image display system according to claim 2, wherein
the second control section makes the second display section continue to display the first image when the request is rejected by the first image display device.

4. The image display system according to claim 1, wherein
the reception section receives an input operation by a user as the instruction of switching the image source.

5. The image display system according to claim 1, wherein
the reception section is the second communication section, and receives the instruction of switching the image source with communication.

6. The image display system according to claim 1 further comprising:
a third image display device, wherein
the first image display device transmits the first image information from the first communication section to the second image display device and the third image display device,
the second image display device and the third image display device display the first image based on the first image information, and
when the reception section receives the instruction while the second image display device displays the first image,
the second control section makes the second display section display the second image, and makes the second communication section transmit the second image information to the first image display device and the third image display device, and
the first image display device and the third image display device display the second image based on the second image information.

7. An image display device comprising:
a communication section configured to receive first image information transmitted from another image display device;
a display section configured to display a first image based on the first image information;
a control section configured to control an operation of the display section and an operation of the communication section; and
a reception section configured to receive an instruction of switching an image source, wherein
when the reception section receives the instruction while the display section displays the first image, the control section makes the display section display a second image and makes the communication section transmit second image information corresponding to the second image to the other image display device.

8. The image display device according to claim 7, wherein
when the reception section receives the instruction while the display section displays the first image, the control section performs a request to change a transmission source of image information to the other image display device, and when the request is allowed by the other image display device, the control section makes the display section display the second image, and makes the transmission section transmit the second image information to the other image display device.

9. The image display device according to claim 8, wherein
the control section makes the display section continue to display the first image when the request is rejected by the other image display device.

10. The image display device according to claim 7, wherein
the reception section receives an input operation by a user as the instruction of switching the image source.

11. The image display device according to claim 7, wherein
the reception section is the communication section, and receives the instruction of switching the image source with communication.

12. A method of controlling an image display system provided with a first image display device and a second image display device, the method comprising:
displaying a first image and transmitting first image information corresponding to the first image to the second image display device by the first image display device;
displaying, by the second image display device, the first image based on the first image information; and
when the second image display device receives an instruction of switching an image source while displaying the first image,
displaying a second image and transmitting second image information corresponding to the second image to the first image display device, and
displaying, by the first image display device, the second image based on the second image information.

13. The method of controlling an image display system according to claim 12, wherein
when the second image display device receives the instruction while displaying the first image, the second image display device performs a request to change a transmission source of image information to the first image display device, and when the request is allowed by the first image display device, the second image display device displays the second image, and transmits the second image information to the first image display device.

14. The method of controlling an image display system according to claim 13, wherein
the second image display device continues to display the first image when the request is rejected by the first image display device.

15. The method of controlling an image display system according to claim 12, wherein
the second image display device receives an input operation by a user as the instruction of switching the image source.

16. The method of controlling an image display system according to claim 12, wherein
the second image display device receives the instruction of switching the image source with communication.

17. The method of controlling an image display system according to claim 12, wherein
the image display system further includes a third image display device,
the first image display device transmits the first image information to the second image display device and the third image display device,
the second image display device and the third image display device display the first image based on the first image information, and
when the second image display device receives the instruction while displaying the first image,
the second image display device displays the second image, and transmits the second image information to the first image display device and the third image display device, and
the first image display device and the third image display device display the second image based on the second image information.
